(19) United States
(12) Patent Application Publication
(10) Pub. No.: US 2025/0006139 A1
(43) Pub. Date: Jan. 2, 2025

(54) BACKLIGHT ADJUSTMENT TECHNOLOGIES

(71) Applicant: Intel Corporation, Santa Clara, CA (US)

(72) Inventors: Susanta BHATTACHARJEE, Bangalore (IN); Mohafiz Ulla KHAN, Bangalore (IN); Greeshma VK, Mysore (IN); Ashish ROY, Jaipur (IN)

(73) Assignee: Intel Corporation, Santa Clara, CA (US)

(21) Appl. No.: 18/217,495

(22) Filed: Jun. 30, 2023

(51) Int. Cl. G09G 3/34

(52) U.S. Cl. CPC G09G 3/3406; G09G 2320/0247; G09G 2320/0626; G09G 2330/021; G09G 2360/16

(57) ABSTRACT

A system that includes at least one processor that is to execute a software to: determine pixel value adjustments based on a limit on contrast loss and to reduce power consumption of a display connected to the display interface and provide the pixel value adjustments to the display interface to apply to pixels of a video frame.

### BACKGROUND

Liquid crystal displays (LCD) utilize various schemes to save power by boosting pixels and reducing the backlight. To reduce power usage, Intel® Display Power Saving Technology (DPST), also known as Content Adaptive Backlight Control, boosts brightness of pixels of displayed frames and reduces LCD backlight proportionally. However, DPST pixel processing can degrade perceived image quality in terms of contrast and brightness loss. Reducing contrast and brightness can impact the visual experience directly.

The amount of pixel boosting or backlight reduction varies from frame to frame. Sudden modification of these parameters can cause visual artifacts, such as flicker. Hence changes to pixel boosting or backlight reduction are smoothened over time to avoid such artifacts. A temporal infinite impulse response (IIR) filter can be used to perform smoothening of pixel values to enhance the image and dim the backlight in a smooth manner.

### BRIEF DESCRIPTION OF THE DRAWINGS

So that the manner in which the features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope.

FIG. 1 depicts step response of an example temporal IIR filter operation.

FIG. 2 depicts an example system.

FIG. 3 depicts an example operation to determine a knee point.

FIG. 4 depicts an example contrast control.

FIG. 5 depicts a DPST transfer function.

FIG. 6 depicts a step response of an example temporal filter operation.

### DETAILED DESCRIPTION

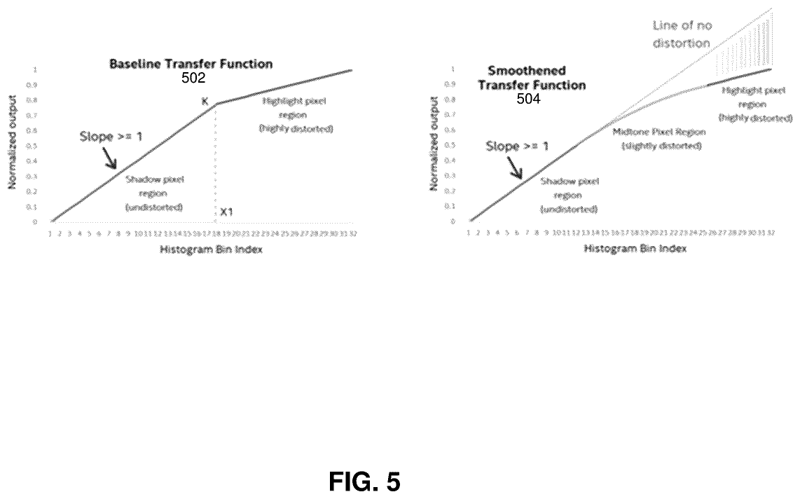

In DPST, darker pixels in the shadow pixel region (e.g., pixels to the left of or below point K in FIG. 5) are boosted linearly whereas brighter pixels in the highlight pixel region are compressed (e.g., pixels with brightness levels above or to the right of point K in FIG. 5) in terms of their value range, leading to contrast loss. DPST applies pixel boosting and corresponding panel backlight adjustment considering histogram of pixel values in the frame being displayed. When the frame changes, these adjustments also change. However, any instant change on the adjustment factors may lead to a flicker, which is an unpleasant visual experience. DPST uses temporal smoothening filters to complete the transition of adjustment factors over time in a phased manner.

Various examples attempt to reduce brightness and contrast loss during pixel processing in connection with backlight reduction and reduction of power usage in a display. Some examples can reduce power usage of a display (e.g., LCD, light emitting diode (LED), organic light-emitting diode (OLED), or others) by modifying pixel values and reducing backlight but limit contrast loss to be within defined limits. Various examples can vary pixel modification or backlight reduction from frame-to-frame and apply a smoothing filter that controls brightness changes over time to reduce visible flicker. For example, an S-curve based smoothening of pixel modification or backlight reduction parameters can be realized using a finite impulse response (FIR) filter that applies a step response shaped as an S.

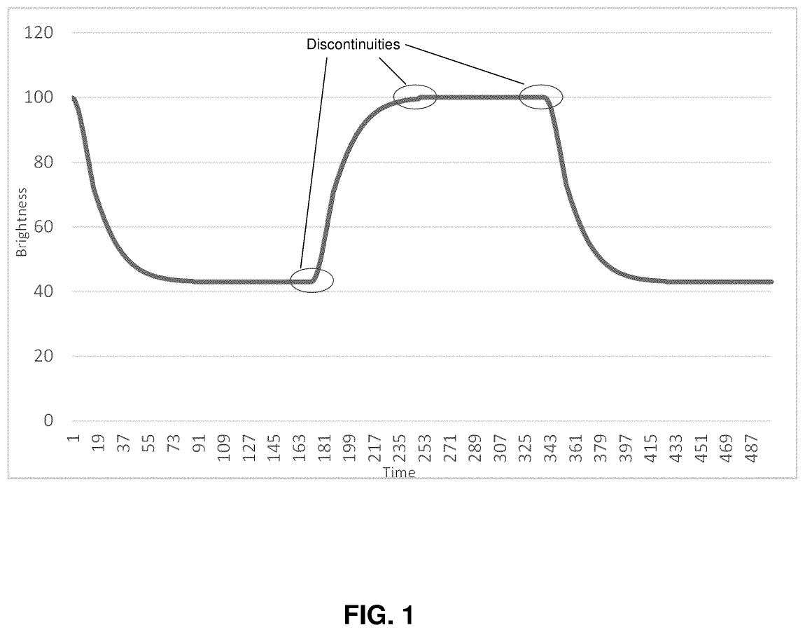

FIG. 1 depicts step response of an example temporal IIR filter operation with regions highlighted where transitions are not smooth or present angled or discontinuous changes. Utilization of such filter provides smoothness of transitions to some extent, but visible flickers can occur.

Various examples attempt to reduce brightness and contrast loss during pixel processing in connection with backlight reduction and reduction of power usage in a display. Some examples can reduce power usage of a display (e.g., LCD, light emitting diode (LED), organic light-emitting diode (OLED), or others) by modifying pixel values and reducing backlight but limit contrast loss to be within defined limits. Various examples can vary pixel modification or backlight reduction from frame-to-frame and can apply a smoothing filter (e.g., a finite impulse response (FIR) filter) that controls brightness changes over time to reduce visible flicker. For example, a step response of the filter can be S-shaped to smoothening of pixel modification or backlight reduction parameters.

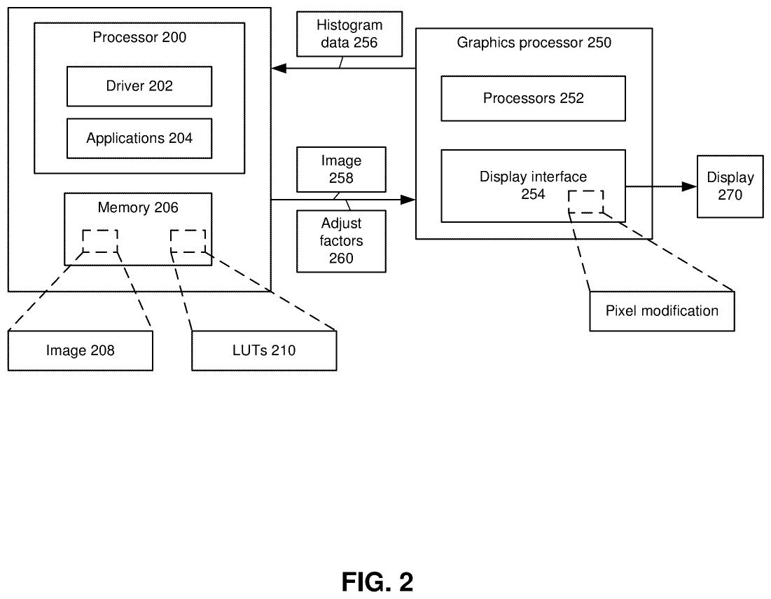

FIG. 2 depicts an example system. Processor 200 can include one or more of: one or more processors; one or more cores; one or more accelerators; one or more application specific integrated circuits (ASICs); one or more field programmable gate arrays (FPGAs); one or more graphics processing units (GPUs); one or more memory devices; or other circuitry described herein. Memory 206 can include one or more of: one or more registers, one or more general register file (GRF), one or more arithmetic logic units (ALUs), one or more accumulators, one or more cache devices (e.g., level 1 cache (L1), level 2 cache (L2), level 3 cache (L3), last level cache (LLC)), volatile memory device, non-volatile memory device, or persistent memory device. For example, memory 206 can include static random access memory (SRAM) memory technology or memory technology consistent with high bandwidth memory (HBM), or double data rate (DDR), among others.

Driver 202 executed by processor 200 can provide access to display interface 254 to an applications 204 executing on processor 200. Application 204 can include creative and business applications such as a word processor, document viewers, web browsers, editors, or others. Applications 204 can remain active for a longer period than utilized and consumer power.

Display interface 254 can read pixels of image 208 from memory 206, process pixels, and stream or output processed pixels to display 270. Image file 208 can include video, one or more still images, audio, metadata, and so forth. For example, pixels can be represented by an 8 bit color value (e.g., 0-255) that represents sub-pixel values using Red, Green, Blue, Hue Saturation Value (HSV), or other color scheme. Display interface 254 can include circuitry or processors to generate a pixel value histogram 256 of a distribution of pixel intensity values (e.g., brightness or max of Red Green Blue (RGB) pixel values) in an image or frames of a video. For example, a pixel value in Hue Saturation Value (HSV) color model (e.g., max(R, G, B)) can be counted in the histogram bins. Pixel value histogram 256 can represent a number of pixel intensity values bucketized into equally (or non-equally) spaced bins of different pixel intensity value ranges. Pixels can be distributed across 32 bins in some examples. For 8 bits per color (bpc) pixels, bins can contain pixel count in value ranges [0, 7], [8, 15] . . . [240, 247], [248, 255].

Driver 202 can process histogram data 256 and parameters associated with programmed power saving aggressiveness (e.g., a user entered setting of power efficiency via a user interface (UI) or manufacturer specified power savings aggressiveness level) and limit on contrast loss (e.g., set by GPU vendor) to determine a configuration for modifying pixel data. Driver 202 can provide such adjustment (adjust) factors 260 to display interface 254. Display interface 254 can multiply R, G and B pixel values by adjustment factors 260.

Driver 202 can identify a transfer function (e.g., FIG. 5) with highest possible shadow region slope and potentially reduces power usage and that keeps contrast or brightness loss within given limits. As shown in FIG. 5, a non-linear curve can be applied for pixel boosting where darker pixels are boosted linearly and brighter pixels are clipped off, leading to contrast loss. Contrast and brightness loss may not be controlled for a given frame. Knee point location K can control power usage and image quality loss. The more the knee point K is towards the left or closer to bin index 1 in transfer function 502, the higher the slope of the line below or to the left of the knee point and the slope of the line above or to the right of the knee point becomes flatter. The higher the slope of the line below or to the left of the knee point, the higher an amount of power saving can occur.

Referring to FIG. 2, driver 202 can apply a configuration for modifying pixel data that attempts to identify a highest shadow region slope to provide increased power savings and keep contrast and brightness loss within given contrast loss limits. For example, contrast and brightness of a displayed frame (along with backlight dimming effect) may be less than or equal to those of the original frame to limit contrast and brightness loss. Example configurations of contrast and brightness loss limits for three aggressiveness levels are provided next as percentages with respect to an original frame. In some examples, low level can represent an allowed contrast reduction up to 80% of original frame and brightness reduction up to 80% of original frame; middle level can represent an allowed contrast reduction of 75% and allowed brightness reduction of up to 75%; and high level can represent an allowed contrast reduction of 70% and brightness reduction or 70%. Example values are exemplary and non-limiting.

Contrast of frame can be estimated based on an associated histogram data 256. A dark bin index can represent a bin index in which the cumulative brightness of pixels associated with lower bin indices up to the dark bin index reaches a predefined low (dark) threshold. A bright bin can represent a bin index where the cumulative brightness value of pixels associated with higher bin indices down to the bright bin index reaches a predefined higher (brightness) threshold level. In some examples, a bright bin index can be associated with a bin with maximum visibility while the cumulative histogram count, starting from highest bin (brightest pixel) reaches 0.5% of the pixel count in the frame. Similarly, some examples may use 1% threshold for a dark bin index. A difference between dark bin index and bright bin index can represent contrast of the frame. These two thresholds can be referred to as “dark pixel threshold” and “bright pixel threshold.”

For example, frame contrast can be determined based on the following:

$$NormalizedFrameContract = ( BrightBinIndex - DarkBinIndex ) / MaxBinIndex ;$$

A frame with single solid color provides NormalizedFrameContrast=0. A frame with sufficient black and white pixels can provide a NormalizedFrameContrast=1.0 For example, a 1920×1080 frame has NormalizedFrameContrast=1.0 if it has >10368 white pixels and >20736 black pixels. This calculation assumes dark pixel threshold of 0.5% and a bright pixel threshold of 1%.

Frame brightness or frame energy can be determined based on a linearized weighted sum of histogram bin counts. The following formula calculates frame brightness in such a way that a full white frame has max brightness=1.0 and full black frame has brightness=0.0.

```
for(each histogram bin)
{
  FrameEnergy += EOTF(NormalizedBinIndex) * PixelCountInBin; Here,
  NormalizedBinIndex = BinIndex / MaxBinIndex;
}
NormalizedFrameBrightness = FrameEnergy / NumPixelsInFrame;
```

EOTF represents electro optic transfer function and can provide a relation between optical output of a panel and input digital pixels values. A dynamic range panel can utilize a power equation (Optical output=(Pixel value)\hat{ }gamma), gamma function with gamma value close to 2.2.

In some examples, a configuration for modifying pixel data includes at least two linear regions joined by at least one knee point corresponding to at least one histogram bin index or number. For example, FIG. 5 depicts examples of configurations for modifying pixel data. Referring back to FIG. 2, driver 202 can determine at least one knee point (K) and slopes of at least a shadow region (e.g., pixels with values are not distorted) and a highlight region (e.g., pixels with values that are distorted). Multiple different transfer functions or pixel adjustment settings with different knee point indices can be applied to pixel values, as represented by look up table (LUT) 210. For a particular knee point index, driver 202 can determine a contrast of an image generated by application of a transfer function. For a video frame or image 208, based on a pixel distribution in histogram data 256 and for each applied transfer function with particular knee point index, driver 202 can determine contrast loss based on a difference between dark and bright bin indices of a frame.

Driver 202 can determine a transfer function with highest shadow region slope (which brings maximum power saving) that keeps contrast/brightness loss within given limits. The shape of the transfer function can be defined by the knee point location. Knee point can be defined at least by: x coordinate (proportional to bin index) and shadow region slope. An example implementation may use two nested search loops to find the x coordinate and shadow region slope. Driver 202 can iterate through bin indices starting from a calculated knee point to maximum possible bin index value. At each of these iterations, contrast and frame energy reductions can be calculated. If contrast reductions and frame energy are within defined limits, a transfer slope can be identified and used to calculate corrections to pixels. In other words, driver 202 can select a particular LUT among LUTs 210 to apply to a frame of pixels. In some cases, as long as a contrast loss limit is met, a power savings target need not be met. In addition, driver 202 (or other software or circuitry) can apply a smoothing operations to smooth transition of lines before value K and after value K in accordance with U.S. Patent Application Publication 2022-0199044.

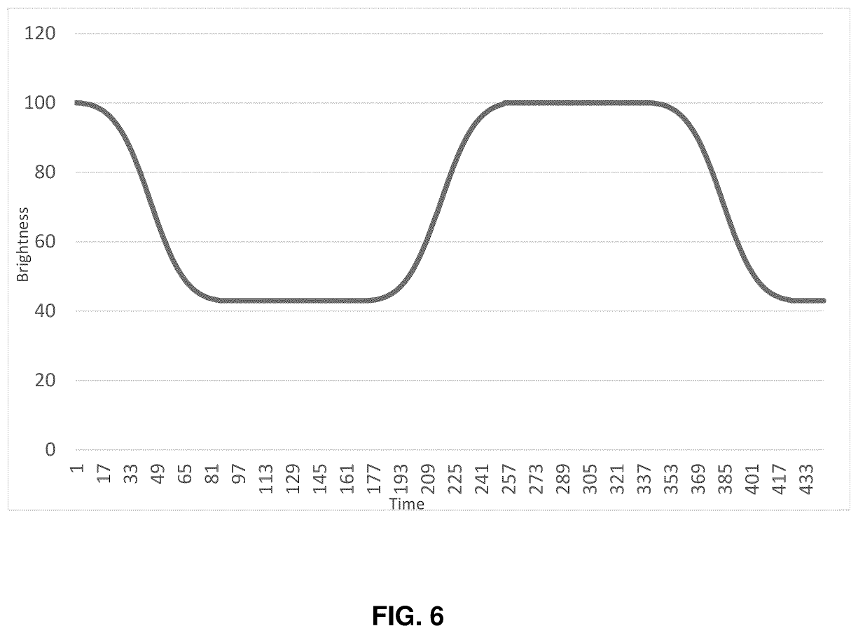

In addition, driver 202 (or other software or circuitry) can apply an S-curve (e.g., FIG. 6) to adjust pixel modification or backlight reduction parameters of the selected LUT Using a S-curve based FIR filter. FIR filter of order N is the weighted sum of the most recent values. When the DPST adjustments, the FIR weights can be determined based on the number of phases and sigmoid function which has a characteristic of S-shaped curve.

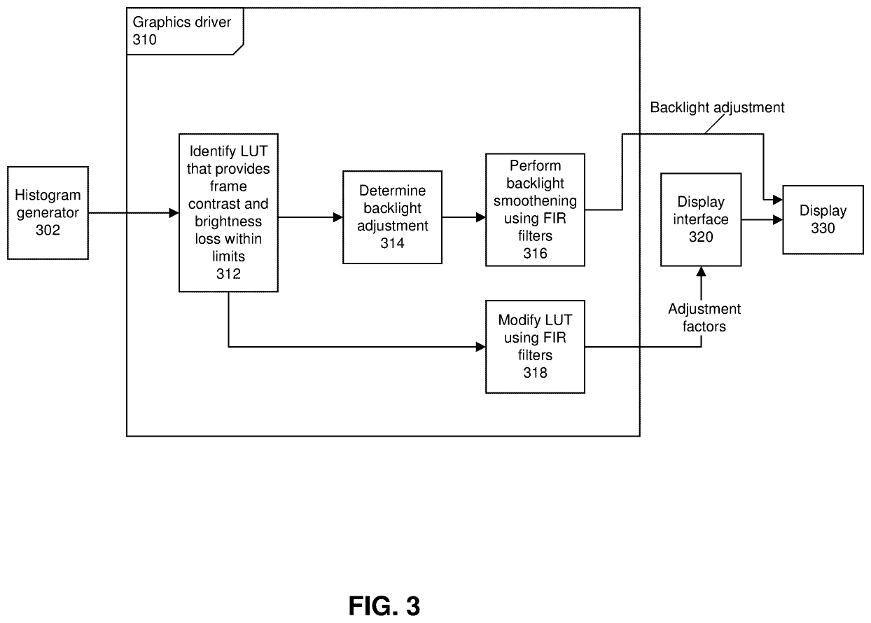

FIG. 3 depicts an example of operations to determine a knee point. Based on histogram data from a histogram generator 302 from a display interface or other circuitry or software, histogram analysis 312 can be performed by graphics driver 310 to determine a knee point that provides power reduction and contrast/brightness loss in accordance with an applicable configuration. For example, at 312, a lookup table can be identified. A lookup table can represent modified output pixels in comparison with input pixels and can represent a curve that represents a transfer function of pixel values. As the curve is non-linear, it is possible that RGB components of a pixel are enhanced by different factors. Driver 310 can calculate entries of a multiplier LUT, in which entries represent boost factors for input pixel value ranges. For example, driver 310 can calculate (Pixel Output/Pixel Input) as a multiplier in a LUT. For example, for pixels represented in HSV, Max(RGB) or V in HSV can be used as a key or input/index to the selected LUT and output of LUT can be a boost factor. For example, for luma mode, brightness or luma can be a key or input/index to the selected LUT and the output from the LUT can be a boost factor.

At 314, driver 310 can determine a backlight adjustment compensating for the determined pixel enhancement. At 316 and 318, driver 310 can perform smoothening of backlight and calculated LUT respectively using S-curve based FIR filter. An FIR filter with Impulse response shaped like Gaussian curve, produces “S” shaped step response. Filtered backlight values can be programmed to display 330 as backlight adjustment and filtered LUT values can be provided to display interface 320 as adjustment factors to modify pixel values.

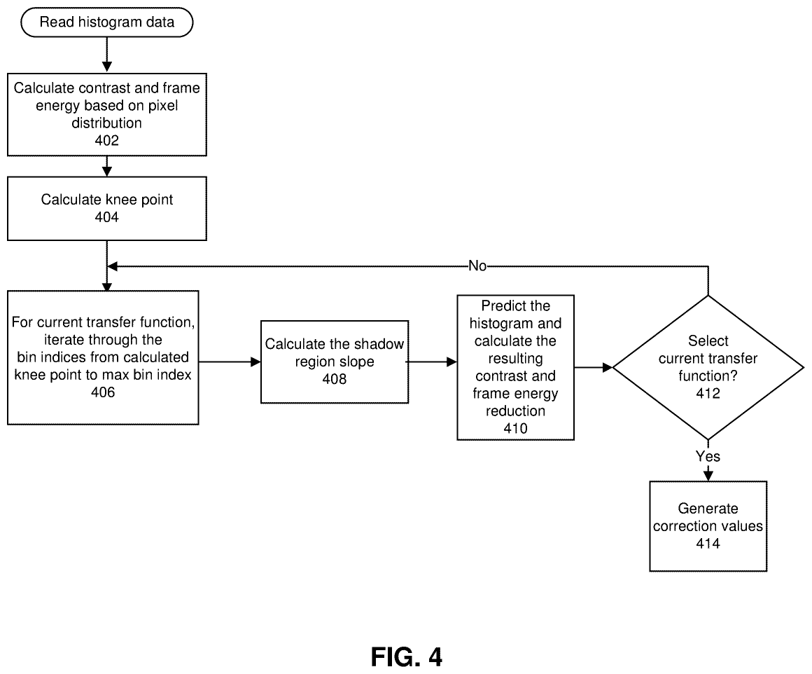

FIG. 4 depicts an example contrast control process to generate correction values for pixels. For example, a GPU or display driver executed by a CPU or other processor can perform the process to identify a transfer function with highest shadow region slope (e.g., lowest bin index value K), which can provide power saving, but also contain contrast and brightness loss to be within given limits. Some examples can apply the process of FIG. 4 to a scenario where a frame is not substantially solid colored.

Panel optical characteristics such as gamma, peak brightness, color accuracy, or others can be measured by displaying a solid color on a full screen. It can be desirable not to change the optical behavior of the panel displaying solid color in a full screen. Hence, pixel processing schemes such as DPST can detect a solid color full screen. Based on a histogram for an image, histogram accumulation method can be used to determine whether a frame is a solid color or not. Example, if more than 95% of the pixels are distributed across two consecutive bins, it is considered as a solid color and the process of FIG. 4 may or may not be applied.

At 402, based on pixel distribution from histogram data, contrast and frame energy can be determined. For example, frame contrast or frame energy can be determined based on a linearized weighted sum of histogram bin counts, as described herein. At 404, a knee point of a particular transfer function among multiple candidate transfer functions can be identified. Operations 406 to 414 can repeat for the multiple candidate transfer functions to identify the candidate transfer function that provides the highest power savings (e.g., frame energy reduction) and meets contrast loss specifications. At 406, a transfer function, among multiple candidate transfer functions, can be selected for analysis. At 408, a shadow region slope can be determined for the transfer function. For example, the slope can be determined based on a shadow region slope from a knee point index value to minimum index value (e.g., index value of 1). At 410, contrast loss and reduction in energy use can be determined by application of the current shadow region slope. At 412, a determination can be made as to whether to select the current transfer function. For example, the current transfer function can be selected based on the reduced contrast being within configured limits and reduction in energy usage associated with the current transfer function is the lowest level. Based on selection of the current transfer function, the process can proceed to 414. Based on non-selection of the current transfer function, the process can proceed to 406 and another candidate transfer function can be selected. At 414, correction of the selected transfer function can be performed to potentially modify the pixel adjustments specified by the selected transfer function.

Note that in some examples, power consumption of a display can be increased by adjusting an applied transfer function, such as based on a user setting or increased availability of energy.

FIG. 5 depicts an example DPST transfer function. Pixels in the shadow region can be undistorted by operations of pixel boosting and backlight dimming. A knee point can be defined by x coordinate (proportional to K bin index) and shadow region slope. However, pixels outside of the shadow region can be clipped, leading to distortion as the pixels may not be adjusted by proportional backlight adjustment. A degree of pixel distortion can be based on the slope of the highlight region of the transfer function. Various techniques described by U.S. Patent Application Publication 2022-0199044 can be used to smooth transition of transfer function before value K and after value K.

FIG. 6 depicts a step response of an example temporal filter operation. By comparison to the response of FIG. 1, the response of FIG. 6 includes smoothened transitions. Some of the advantages of using FIR over IIR are better control over time as FIR filter predetermines the number of taps concluding the DPST transition in the desired duration and FIR need not have to maintain the threshold to end transition. For example, correction of the selected transfer function can include inter-frame brightness adjustments so that selected transfer functions do not change more than limits specified by a curve such as that of FIG. 6.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.′”

Illustrative examples of the devices, systems, and methods disclosed herein are provided below. An embodiment of the devices, systems, and methods may include one or more, and combination of, the examples described below.

Example 1 includes one or more examples and includes an apparatus comprising: a display interface and at least one processor, wherein the at least one processor is to execute a driver to: determine pixel value adjustments based on a limit on contrast loss and to reduce power consumption of a display connected to the display interface and provide the pixel value adjustments to the display interface to apply to pixels of a video frame.

Example 2 includes one or more examples, wherein the pixel value adjustments comprise a first adjustment to a shadow pixel region and wherein an amount of reduction of power consumption of the display is based on a slope of pixel value output as a function of pixel value in the shadow pixel region.

Example 3 includes one or more examples, wherein the driver executing on the processor is to select a pixel adjustment setting among multiple pixel adjustment settings.

Example 4 includes one or more examples, wherein the multiple pixel adjustment settings are stored in a memory in at least one look-up-table.

Example 5 includes one or more examples, wherein the driver executing on the processor is to limit an amount of brightness change between pixel positions in different frames based on a sigmoid function applied using a finite impulse response (FIR) filter.

Example 6 includes one or more examples, wherein the driver executing on the processor is to provide the pixel value adjustments to the display interface to modify pixel values based on the pixel value adjustments.

Example 7 includes one or more examples, wherein the pixel value adjustments comprise changes to pixel brightness.

Example 8 includes one or more examples and includes a graphics processing unit (GPU) coupled to the display interface, wherein the GPU is to generate a histogram of pixel value distributions for a frame of video and wherein the driver is to determine pixel value adjustments based on the limit on contrast loss and the histogram of pixel value distributions for the frame of video.

Example 9 includes one or more examples, and includes a display, wherein the display is to display pixels of the video frame subject to the pixel value adjustments.

Example 10 includes one or more examples, and includes reducing power usage of a display by selecting a pixel value adjustment setting that reduces pixel value adjustments in a shadow region of a frame of video and limits contrast loss.

Example 11 includes one or more examples, and includes limiting an amount of brightness change between pixel positions in different frames based on a sigmoid function applied using a finite impulse response (FIR) filter.

Example 12 includes one or more examples, and includes providing the selected pixel value adjustment setting to a display interface to modify pixel values based on the selected pixel value adjustment.

Example 13 includes one or more examples, wherein the pixel values comprise Red Green Blue (RGB) pixel values or Hue Saturation Value (HSV) pixel values.

Example 14 includes one or more examples, wherein the selected pixel value adjustment causes changes to displayed pixel brightness.

Example 15 includes one or more examples, wherein the selecting a pixel value adjustment setting that reduces pixel value adjustments in a shadow region of a frame of video and limits contrast loss is based on a histogram of pixel value distributions for the frame of video.

Example 16 includes one or more examples, and includes a non-transitory computer-readable medium comprising instructions stored thereon, that if executed by one or more processors, cause the one or more processors to: execute a display interface driver that is to: determine pixel value adjustments based on a limit on contrast loss and to reduce power consumption of a display connected to a display interface and provide the pixel value adjustments to the display interface to apply to pixels of a video frame prior to display of the pixels.

Example 17 includes one or more examples, wherein the determine pixel value adjustments based on a limit on contrast loss and to reduce power consumption of a display connected to a display interface comprises select pixel value adjustments from among multiple configurations of pixel value adjustments.

Example 18 includes one or more examples, wherein the determine pixel value adjustments based on a limit on contrast loss and to reduce power consumption of a display connected to the display interface is based on a histogram of pixel value distributions for the frame of video.

Example 19 includes one or more examples, and includes instructions stored thereon, that if executed by one or more processors, cause the one or more processors to: execute the display interface driver that is to limit an amount of brightness change between pixel positions in different frames based on a sigmoid function applied using a finite impulse response (FIR) filter.

Example 20 includes one or more examples, wherein the pixel value adjustments comprise changes to pixel brightness.

What is claimed is:

1. An apparatus comprising:
a display interface and
at least one processor, wherein the at least one processor is to execute a driver to:
determine pixel value adjustments based on a limit on contrast loss and to reduce power consumption of a display connected to the display interface and
provide the pixel value adjustments to the display interface to apply to pixels of a video frame.

2. The apparatus of claim 1, wherein the pixel value adjustments comprise a first adjustment to a shadow pixel region and wherein an amount of reduction of power consumption of the display is based on a slope of pixel value output as a function of pixel value in the shadow pixel region.

3. The apparatus of claim 1, wherein the driver executing on the processor is to select a pixel adjustment setting among multiple pixel adjustment settings.

4. The apparatus of claim 3, wherein the multiple pixel adjustment settings are stored in a memory in at least one look-up-table.

5. The apparatus of claim 1, wherein the driver executing on the processor is to limit an amount of brightness change between pixel positions in different frames based on a sigmoid function applied using a finite impulse response (FIR) filter.

6. The apparatus of claim 1, wherein the driver executing on the processor is to provide the pixel value adjustments to the display interface to modify pixel values based on the pixel value adjustments.

7. The apparatus of claim 1, wherein the pixel value adjustments comprise changes to pixel brightness.

8. The apparatus of claim 1, comprising a graphics processing unit (GPU) coupled to the display interface, wherein the GPU is to generate a histogram of pixel value distributions for a frame of video and wherein the driver is to determine pixel value adjustments based on the limit on contrast loss and the histogram of pixel value distributions for the frame of video.

9. The apparatus of claim 1, comprising a display, wherein the display is to display pixels of the video frame subject to the pixel value adjustments.

10. A method comprising:
reducing power usage of a display by selecting a pixel value adjustment setting that reduces pixel value adjustments in a shadow region of a frame of video and limits contrast loss.

11. The method of claim 10, comprising:
limiting an amount of brightness change between pixel positions in different frames based on a sigmoid function applied using a finite impulse response (FIR) filter.

12. The method of claim 10, comprising:
providing the selected pixel value adjustment setting to a display interface to modify pixel values based on the selected pixel value adjustment.

13. The method of claim 12, wherein the pixel values comprise Red Green Blue (RGB) pixel values or Hue Saturation Value (HSV) pixel values.

14. The method of claim 10, wherein the selected pixel value adjustment causes changes to displayed pixel brightness.

15. The method of claim 10, wherein the selecting a pixel value adjustment setting that reduces pixel value adjustments in a shadow region of a frame of video and limits contrast loss is based on a histogram of pixel value distributions for the frame of video.

16. A non-transitory computer-readable medium comprising instructions stored thereon, that if executed by one or more processors, cause the one or more processors to:
execute a display interface driver that is to:
determine pixel value adjustments based on a limit on contrast loss and to reduce power consumption of a display connected to a display interface and
provide the pixel value adjustments to the display interface to apply to pixels of a video frame prior to display of the pixels.

17. The non-transitory computer-readable medium of claim 16, wherein the determine pixel value adjustments based on a limit on contrast loss and to reduce power consumption of a display connected to a display interface comprises select pixel value adjustments from among multiple configurations of pixel value adjustments.

18. The non-transitory computer-readable medium of claim 16, wherein the determine pixel value adjustments based on a limit on contrast loss and to reduce power consumption of a display connected to the display interface is based on a histogram of pixel value distributions for the frame of video.

19. The non-transitory computer-readable medium of claim 16, comprising instructions stored thereon, that if executed by one or more processors, cause the one or more processors to:
execute the display interface driver that is to limit an amount of brightness change between pixel positions in different frames based on a sigmoid function applied using a finite impulse response (FIR) filter.

20. The non-transitory computer-readable medium of claim 16, wherein the pixel value adjustments comprise changes to pixel brightness.
